(19) United States
(12) Patent Application Publication
(10) Pub. No.: US 2003/0088658 A1
(43) Pub. Date: May 8, 2003

(54) Obtaining information to facilitate system usage

(76) Inventors: Ian R. Davies, Longmont, CO (US); Phil Colline, Irvine, CA (US)

Correspondence Address: SHERIDAN ROSS PC, 1560 BROADWAY, SUITE 1200, DENVER, CO, 80202

(21) Appl. No.: 10/045,590

(22) Filed: Nov. 8, 2001

(51) Int. Cl. G06F 15/173; G06F 15/16

(52) U.S. Cl. 709/223; 709/227

(57) ABSTRACT

A method and system are disclosed for assisting an administrator of a system, such as including a storage area network (SAN), in managing tasks that may include tasks related to data storage, wherein typically a plurality of host systems contact the SAN. The system (i) detects a new host contact that is the result of a bus scan on the new host (H), (ii) captures a world wide (WWN) for H provided by the bus scan, (iii) uses the WWN to retrieve additional information describing H from, e.g., a fiber channel switch, (iii) presents both the WWN and the additional information for H to the administrator, wherein the presentation is distinguished from presentations of other hosts, and (iv) allows the administrator to modify the presentation for H by adding to or replacing at least a portion of the presentation for H with further data that makes it easier for the administrator to identify the presentation for H from corresponding presentations for other hosts. Since the system uses a host bus scan to contact the SAN, no special purpose software is required on the hosts.

### RELATED FIELD OF THE INVENTION

The present invention relates to facilitating management of a system using a controller that is accessible by one or more hosts via a network, and in particular, to assisting a system administrator associated with the system in obtaining and utilizing more easily recognizable descriptions for hosts.

### BACKGROUND

Management of systems including those having data storage available to computers via a network can be a difficult task for system administrators. For example, if a system administrator desires to provide a computer, such as a “host” computer, with access to data storage residing on a network (e.g., a fibre channel network), this administrator must typically cause a unique identifier to be provided to the controller that allows network access to the desired data storage. Since substantially every computational component has a unique identifier (denoted herein as the “world wide name”), such a host identifier may be such a world wide name of the host interface component to the network. However, such a world wide name (WWN) may be long and difficult for humans to reliably recognize and duplicate. For instance, one currently used standard for providing uniquely identifying world wide names provides such names as typically a long hexadecimal identifier (e.g., 16 hexadecimal digits). Thus, heretofore it has not been easy to reliably communicate such WWNs for gaining access to such network data storage. For example, a host administrator has, in some cases, had to manually obtain such a WWN of a host adapter by locating where the WWN is physically provided on the host adapter component. Accordingly, this task may entail a partial disassembly of the host. Alternatively, the host administrator (or in some cases the system administrator for the controller providing access to the network data storage) may need to activate specially installed procedures on the host, wherein these procedures are used to obtain the host adapter's WWN, and transmit the WWN to the controller for the network data storage. In either case, such a WWN must be communicated to the storage management procedures provided by (or associated with) the controller so that proper data storage access becomes available to the host.

There are various ways to communicate such a host adapter WWN to a controller (e.g., network storage controller) depending on the circumstances. If the host system administrator and/or the system administrator for the system providing the desired network data storage (such a system commonly accessed by such hosts by what is referred to in the art as a “storage area network” or SAN) can activate (either at the host or remotely) the specially installed host procedures, then the WWN may be subsequently transferred to the storage controller. If such system administrators do not have such specially installed procedures available, then typically the host system administrator has heretofore been required to explicitly cause such a WWN to be communicated to the system providing the desired network data storage in order for data storage access privileges to be provided to the host. Accordingly, if the host administrator is not the administrator of the system providing the desired network data storage (also denoted hereinafter as the “network storage system”), then the host administrator may have to take steps to verbally or electronically provide the WWN to the administrator of the network storage system so that the two system administrators can then cooperate in assuring that the host has appropriate access to the network data storage.

However, regardless of how such a WWN has been heretofore provided to the network storage system, it has either required the active participation of the host administrator in providing the WWN to the network storage system, or, there has been specially designed (e.g., network storage system vendor specific/proprietary) application software that must be installed (and maintained) on the host so that the WWN can be provided to the network storage system. Accordingly, it would be advantageous if such WWNs could be provided to a network storage system both with reduced system administrator effort, and without requiring the installation and maintenance of such vendor specific software on hosts for providing WWNs to the network storage system.

Moreover, it has been heretofore difficult for the network storage system administrator to identify and/or easily associate which WWNs correspond with which hosts. For example, a network storage system administrator may need to obtain a WWN for a particular host for which he/she is also host administrator (e.g., when it is required to give or modify access to the network storage system). Accordingly, even if such a host WWN can be provided substantially automatically in a request to the network storage system, unless the network storage system administrator has some way of distinguishing this WWN from the potentially large number of substantially concurrent storage access requests from other hosts, it is not uncommon for the transmittal of the host's WWN to be buried within a log of network storage system access requests from other hosts, each of which also includes a WWN. Additionally, as mentioned hereinabove, WWNs may be hexadecimal digit strings of 16 digits, and such WWNs may have very similar digit strings. Thus, the network storage system administrator can be forced to review some portion of the network storage system's access request log and attempt identify a (possibly unknown) 16 digit hexadecimal WWN from among other 16 digit hexadecimal WWNs of other hosts. This task is unpleasant, and can be tedious as well as error prone in that humans are not adept at easily recognizing such long hexadecimal strings. Moreover, there are other similar situations that face network storage system and/or host system administrators. For example, heretofore if a system administrator for a host, H, contacts the network storage system administrator and requests, e.g., a change to data storage access rights for H, then either the host administrator must communicate the host's WWN to the network storage system administrator, or one of the system administrators must activate one of more processes on the host to obtain the WWN. In either case, assuming the host H has been accessing the data storage of the network storage system, the WWN for the host H is known to the network storage system, but such information has not heretofore been available to the network storage system administrator in a manner with which he/she can use to modify data storage access permissions. Accordingly, the network storage system administrator must effectively re-acquire the association of the host with the host's WWN.

Accordingly, it would also be advantageous for there to be network storage system user interface functionality that assists the network storage system administrator in more easily identifying hosts requesting access to the network storage system, and in identifying hosts presently accessing the network storage system. In particular, it would be desirable for the network storage system to have a user interface that both allows the network storage system administrator to more easily identify the WWNs of new hosts as well as more easily identify the hosts currently accessing the network storage system.

### DEFINITION OF TERMS

Storage Area Network (SAN): This term herein refers to a communications network for transmitting data storage access requests from a host to a network storage system, and for transmitting any resulting data retrieved from the data storage of the network storage system to the host. Note there may be a large plurality of hosts (e.g., thousands) connected to the SAN for transmitting such requests to a network storage system, and there may be one or more network storage systems connected to the SAN for responding to such host requests.

Network Storage System (NSS): This term herein refers to a node on a SAN which provides host access to data storage controlled by the NSS. Such a NSS limits or controls access to such data storage according to access permissions that are granted (or not granted) to individual hosts.

Logical Unit Number (LUN): Depending on the context, this term denotes herein: (a) an identifier for identifying a partition of a data storage provided by a network storage system, and/or (b) the actual data storage partition corresponding to such an identifier.

Bus scan: A functional component of a host computer's operating system that is conventionally used for identifying the devices that are operationally attached to a bus for the host computer for communicating information on the bus. The bus scan functionality is activated upon host computer boot up, so that the host can determine the devices with which it can communicate via the bus. However, in the present invention, such a bus scan is used for the novel purpose of providing host information about the host to a network storage system via transmissions on a storage area network (SAN), wherein the network storage system (NSS) uses the host information for configuring host access to one or more LUNs whose storage permission access is controlled by the network storage system.

FC device cloud: This is the nodes and data transmission equipment of a connected portion of a storage area network.

LUN zoning: A method of assigning access permissions to one or more previously created LUNs. Note that LUN zoning creates and/or modifies a “LUN zoning table” that is the data structure for retaining the access permissions provided by the method of LUN zoning.

Active-active fail over: A mode of operation where two storage controllers of a network storage system cooperate to provide continuous access to the same data storage of the network storage system regardless of whether one of the storage controllers fails.

Failback of zoning information: Failback refers to transferring access control for data storage from a temporary storage controller of a network storage system to a more preferred storage controller of the network storage system. When control of storage access is transferred, then the LUN zoning tables (specifying host access rights) must be transferred also.

LUN gaps: LUNs are normally assigned contiguous integer numbers (0−n). A LUN gap occurs when the LUNs provided to a host by a network storage system are not contiguous, or do not start with LUN zero. Some host operating systems do not provide access to all LUNs when storage controllers have LUN gaps.

New host: This term refers to a host that has recently performed a bus scan for contacting one or more network storage systems 108 (FIG. 1) on a storage area network 112, wherein the term “contacting” in the context of a bus scan includes providing information that is subsequently used by one or more of the network storage systems to provide access permissions to data storage that they control. Note, however, such a network storage system 108 may have previously obtained identification information about the new host, wherein such information was retained from a time when the new host previously had access the network storage system.

World Wide Name: This term denotes herein a unique identifier for a computational device, wherein this identifier is accessible for transmission on a storage area network for uniquely identifying the computational device to other devices on the storage area network.

### SUMMARY

The present invention is directed, at least in part, to assisting computer system administrators with managing a system that includes at least one controller and one or more hosts that communicate with the controller. In a preferred embodiment, the system has data storage available to the host(s) using a communications network, such as a storage area network (SAN) and the controller. In particular, the present invention is directed to assisting system administrators in more easily obtaining identifications of host computers, including those that need access to particular data storage portions of a network storage system (NSS). More particularly, the present invention provides system administrators with the ability to more easily and reliably obtain a world wide name (WWN) for a host, wherein the WWN is obtained substantially automatically without requiring NSS vendor specific/proprietary software to be installed on the host.

The present invention provides a controller with the capability to more easily obtain a WWN for a host or more specifically, the present invention provides the controller with the capability to more easily obtain a WWN of an electronic component associated with the host (typically a network interface component known in the art as a “host adapter”). In particular, the controller of the present invention retrieves such WWNs by substantially reducing the manual tasks required to be performed and does this without requiring additional software on the host beyond functionality provided by commercially available host operating systems (e.g., WINDOWS NT, UNIX, etc.). More particularly, for obtaining a host adapter WWN (of a host H), it is an aspect of the invention to obtain this WWN from an activation of a host “bus scan” (as it is known in the art) wherein the host activates a process, in the host's operating system, for identifying all devices (e.g., storage devices) that are currently accessible to the host (e.g., via the host's bus). A more detailed definition of the term “bus scan” as used herein is provided in the Definition Of Terms section hereinabove. Accordingly, the host bus scan transmits the WWN of the host's host adapter to the controller and the controller is able to capture this WWN, and use it to automatically obtain additional information related to the host adapter such as the host adapter's manufacturer, make and/or model as well as possibly other information such as the host's IP address and machine name (as will be further described below). Subsequently, the WWN plus (any) additional related information is provided to the network storage system administrator so that he/she can then provide appropriate network storage system data storage access rights to the host.

In a related aspect, the present invention provides desired functionality for presenting such WWNs to an administrator. In particular, the WWN provided with each most recently received system access request is, in one embodiment, provided at the top or head of a list displayed to the system administrator so that the system administrator is able to more easily identify new hosts to facilitate use or management of the system.

Moreover, in a further related aspect, the present invention provides additional desired functionality that allows the system administrator to associate descriptive information with the WWN identifying a host. In particular, the system administrator may create such an association so that it is easier for the administrator to identify a host by such descriptive information than by, e.g., the host's 16 hexadecimal digit WWN. Furthermore in some embodiments, the system administrator can use this descriptive information (instead of the corresponding WWN) in NSS operations for assigning and/or changing storage access rights. For example, the administrator may use the descriptive information for enabling or disabling LUN access.

In yet a further related aspect, the present invention also associates: (a) the above referred to automatically captured “additional information” related to a host (more particularly, the host's host adapter), and (b) the host's corresponding WWN so that such additional information may be used in, e.g., determining the network capabilities of the host. In one embodiment of the invention, this additional information may be provided as the default value for the “descriptive information” also associated with the WWN identifying the host.

Additional features and benefits of the present invention will be evident from the accompanying figures and Detailed Description hereinbelow.

### BRIEF DESCRIPTION OF THE DRAWINGS

FIG. 1 is a high level block diagram of the components of a preferred embodiment of the present invention in an operational context wherein network communications between a storage controller and the hosts requesting NSS 108 access are provided via the storage area network 112.

FIG. 2 is a high level flowchart of the steps performed when the storage controller 142 is contacted by a host 104.

FIG. 3 is a high level flowchart of the steps performed for registering a new host 104 with the present invention, wherein the NSS administrator may provide a more descriptive alias for the world wide name of the host 104.

FIGS. 4A-4C provide illustrative examples of screen displays of a NSS user interface according to the present invention.

### DETAILED DESCRIPTION

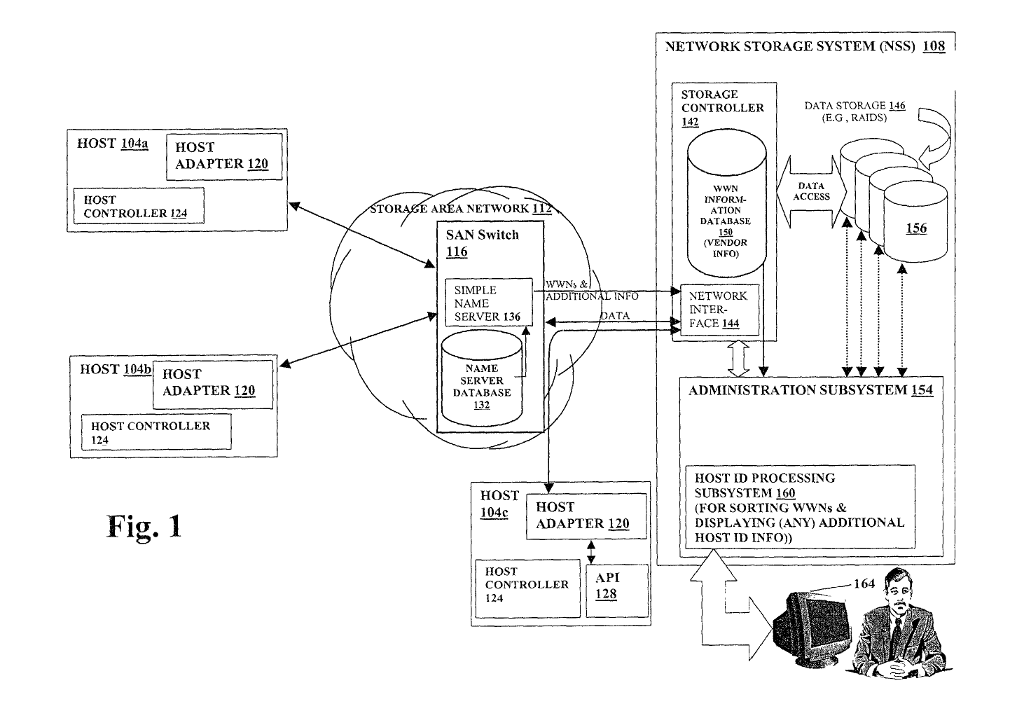

In FIG. 1 a high level block diagram is shown of the present invention and associated components of the computational/network environment with which the present invention operates. The computational/network environment includes a plurality of host computers 104 (also simply denoted as “hosts” herein), wherein each such host 104 has a network connection to the storage area network 112 (SAN) for accessing data storage 146 of the network storage system (NSS) 108 not otherwise available to the host. In particular, FIG. 1 shows three such hosts (104a, 104b and 104c). However, the number of hosts 104 may vary from one to hundreds (if not thousands) as one skilled in the art will understand. In the embodiment of FIG. 1, the hosts 104a, 104b and 104c communicate with the NSS 108 by way of the storage area network 112 which in one embodiment may be a fibre channel network. Moreover, for the hosts 104a and 104b, communications with the NSS 108 are routed by a SAN switch 116 (e.g., a fibre channel switch) which may operate to route communications between a plurality of hosts 104 and a plurality of NSSs 108 as one skilled in the art will understand. Note that host 104c connects directly to the NSS 108 via the storage area network 112. In particular, the host 104c is likely to be relatively close to the NSS 108 in comparison to the hosts 104a and 104b (e.g., host 104c may be co-located with the NSS).

Each of the hosts 104 includes a host adapter 120 which provides the network interface functionality for receiving and transmitting communications on the storage area network 112. Host adapters 120 are manufactured by various companies including Qlogic Corporation, 26600 Laguna Hills Drive, Aliso Viejo, Calif. 92656, and Agilent Technologies 395 Page Mill Rd. P.O. Box #10395, Palo Alto, Calif. 94303. Moreover, as with most commercial computational devices, each such host adapter 120 has, both electronically encoded therein and labeled thereon, a world wide name (WWN) that uniquely identifies the host adapter 120. In at least some embodiments of the invention, the WWN of such host adapters 120 is used to identify the corresponding host 104 in storage area network 112 communications. Moreover, by using the world wide names of such host adapters 120, there is an added benefit that such names can be used to provide the manufacturer of such host adapters. However, it is within the scope of the present invention that the world wide names of other components of a host 104 may also be used to identify the host. Accordingly, the term WWN will be used to refer to a world wide name of some component of a host having the component, and, in some contexts will refer to the world wide name of the host's host adapter 120. However, the latter more specific meaning for WWN is intended when aspects and/or embodiments of the invention must provide component identifying information that is specific to the functionality of a host adapter.

Additionally, each host 104 is also illustrated as having a host controller 124 which typically can be considered to include the host's operating system plus a user interaction (not shown) system that allows, e.g., a host system administrator to perform system administration functions such as for facilitating the provisioning of NSS 108 storage access as one skilled in the art will understand. Moreover, at least some of the hosts 104 (and in particular, host 104c in FIG. 1) further have various application programming interfaces 128 (API) for communicating with the host's host adapter 120 for thereby supplying an application program (utilizing the API) with access to NSS 108 data storage.

Regarding the SAN switch 116, included therein (or accessible thereby) is a name server database 132. This database 132 captures host identification data provided by hosts 104 using the SAN switch to access the NSS 108. In particular, the name server database 132 includes the following information provided by host 104 when the host accesses the SAN switch 116: the WWN for the host, the host network address, and the communications protocol being used by the host. Additionally, the name server database 132 may also capture such additional information, such as the make and model of the component corresponding to the WWN, and a host identification name. The SAN switch 116 also includes a simple name server subsystem 136 which can be used for querying the name server database 132. In particular, the simple name server subsystem 136 can access the name server database 132 to satisfy queries for additional information related to a host 104 when the query identifies the host by its WWN.

In at least some embodiments of the present invention, it is the WWN of each such host adapter 120 that is utilized to obtain additional information.

Referring now to the network storage system (NSS) 108, this component includes a storage controller 142 for controlling access to the data storage 146. The storage controller 142 includes an network interface 144 for receiving SAN network 112 transmissions from, e.g., the hosts 104. The storage controller 142 includes components for enforcing storage data access constraints (also denoted herein as “permissions”) to logical storage partitions of the data storage 146 via a process commonly known as LUN zoning. In particular, the storage controller 142 provides hosts 104 (via the network interface 144 of the storage controller) with access permissions to one or more logical storage units of the data storage 146 by:

(i) identifying each host 104 (e.g., by its corresponding WWN),

(ii) accessing a “zone table” (described below) for determining if the host has permission to access such a logical storage unit, and

(iii) subsequently either providing the requested access or responding to the host with a message indicating that access is denied.

As indicated previously, the storage controller 142 and the hosts 104 use logical unit numbers (LUNs) assigned to such logical storage units of the data storage 146 such that each such logical storage unit is identified by a unique LUN. Accordingly, to access the data storage 146 a requesting host 104 must provide the LUNs for the logical storage units to be accessed. Thus, it is typical for each host 104 to have the LUN for each logical storage unit, accessible by the host, to be resident on the host.

The storage controller 142 also interacts with an administration subsystem 154 which, in turn, interacts with the NSS administrator to manage the NSS 104. Thus, the storage controller 142:

(a) receives instructions from the administration subsystem 154; e.g., NSS administrator instructions requesting that the storage controller 142 obtain the WWN of a particular host 104;

(b) receives updates to the zone table wherein data storage 146 access permissions are modified for one or more hosts 104, and

(c) provides to the administration subsystem 154 data identifying each host 104 that is interrogating the storage controller 142 as to whether the data storage 146 is available for access.

The present invention provides novel functionality in that for each new host 104 (i.e., hosts that have performed a bus scan to contact network storage system 108), a process may be initiated thereon for obtaining the host's WWN without requiring the host to have resident thereon software specifically designed and intended to cooperate with the storage controller 142. Furthermore, in at least in some cases, such a process is activated without further manual effort (e.g., by the host or NSS administrator). In particular, a host system will automatically issue a bus scan when it boots, as is well known to one skilled in the art. Thus, for each new host 104, such a bus scan activated on the new host identifies peripheral devices operatively connected to the bus of the new host. Accordingly, the new host has been previously configured so that, during its bus scan, data is accessed on the host wherein this data identifies the NSS 108 (and in particular the storage controller 142) as a peripheral storage device that should be operatively connected to the host's bus. Thus, the bus scan causes a message (having the host's WWN) to be transmitted to the storage controller 142. Additionally, when the host bus scan transmits the message to contact the storage controller 142 for determining whether the storage controller is operable, the storage controller captures: (a) the host's WWN for providing to the NSS administrator so that he/she can modify the zone table for providing access permissions to the new host, and optionally (b) a timestamp of when the contact occurred.

Moreover, the storage controller 142 also includes (or has access thereto) a WWN information database 150 which stores, for host WWNs, corresponding manufacturers and makes of the components (e.g., host adapters 120) identified by the WWNs. Thus, the storage controller 142 can input a new host's WWN to the WWN information database 150 and determine from the database the manufacturer of the component corresponding to the input WWN. Note that such WWN information databases 150 are publicly-available from IEEE at IEEE Operations Center, 445 Hoes Lane, P.O. Box 1331, Piscataway, N.J. 08855-1331 USA (Internet URL: www.IEEE.org). However, such databases, in general, do not provide detailed descriptions of computational components according to their WWNs. In fact, for each WWN, such databases typically supply substantially only the manufacturer, but sometimes may supply the make and/or model of the component having the WWN.

Additionally, the storage controller 142 is novel in that it actively attempts to obtain additional information about hosts 104 seeking to access the data storage 146. In particular, upon receiving the WWN of a new host 104, via a bus scan, the storage controller 142 attempts to obtain additional information related to the computational characteristics of the new host so that, e.g., the NSS administrator may be provided with such additional host information to thereby make it easier for the NSS administrator to identify the new host. That is, the additional information for a host 104 is associated with the WWN for the host so that the NSS administrator can use the additional information to identify the host rather than use the host's WWN for such identification. In particular, the storage controller 142 automatically (i.e., without requiring manual intervention) initiates one or more queries for additional information about the new host, wherein such queries are directed to various databases having such additional information. More particularly, the storage controller 142 proactively and automatically uses the new host's WWN to generate queries to one or more of: the name server database 132 (via the network interface 144), and the WWN information database 150 for obtaining whatever additional information is available that describes the new host 104. When querying the name server database 132, one or more of the following data items may be retrieved by the storage controller 142: (i) an identification of a make, model and/or manufacturer of a component of the new host, (ii) a network address of the new host, (iii) a communications protocol being used by the new host for communicating on the SAN network 112, and (iv) an identification name (different from the WWN) of the new host. When querying the WWN information database 150, the storage controller 142 may, in some embodiments, only retrieve the manufacturer of the component of the new host having WWN for the new host.

Further note that such additional host information can provide the NSS administrator with useful information about the new host 104 such as its ASCII network node name, and its IP address. For example, if the new host's WWN is the world wide name of the host's host adapter 120, then this additional information can be used by the NSS administrator to distinguish between host systems using different host adapter 120 types. Thus, the present invention is directed, at least in part, to relieving at least some of the burden of gathering and providing to a network storage system administrator such additional information about the hosts requesting access to the NSS 108.

Referring to the administration subsystem 154 in more detail, this subsystem receives information from the storage controller 142 regarding hosts 104 that are, e.g., performing bus scans. The administration subsystem 154 uses such information to inform a NSS administrator (via, e.g., display 164) of hosts 104 that need access to the data storage 146. Additionally, the administration subsystem 154 maintains the zone table by providing the functionality for:

(a) assigning, and deleting to LUNs, partitions of the data storage 146;

(b) assigning, deleting and modifying host permissions to the logical units of the data storage 146; and

(c) interacting with the NSS administrator thereby providing the NSS administrator with information related to NSS 108 usage and health (e.g., NSS 108 errors).

Moreover, the administration subsystem 154 communicates directly with data storage devices of the data storage 146 for, e.g., (re)partitioning one or more of the storage devices, activating and deactivating one or more of the storage devices, replacing a failed storage device, reconstructing corrupted data on the storage devices.

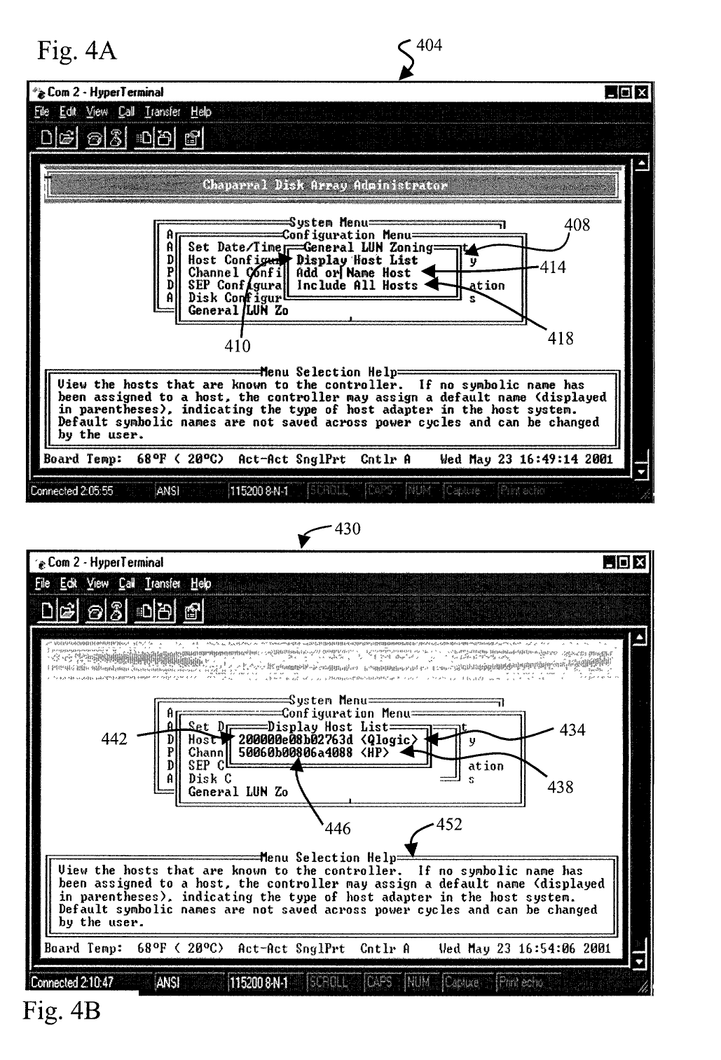

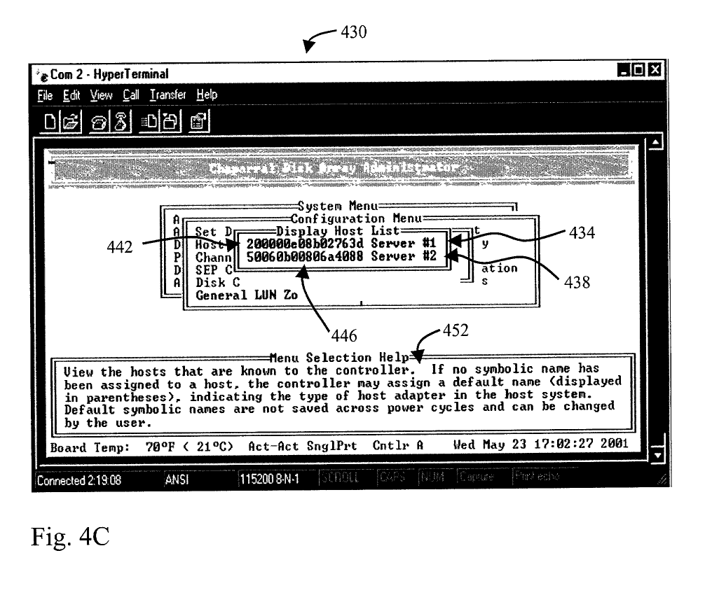

Additionally, the administration subsystem 154 includes a host ID processing subsystem 160 for presenting to the NSS administrator host identification information in a particularly novel and useful fashion that better meets the NSS administrator's needs. In particular, the host ID processing subsystem 160 orders or sorts the host information that has been captured by the storage controller 142 (e.g., via host bus scans) so that the host(s) 104 that have most recently captured host information is easily identified by the NSS administrator. That is, since there may be hundreds (or even thousands) of hosts 104 accessing the NSS 108, the present invention presents a list identifying every such host 104 to the NSS administrator, wherein the most recently received host identification information (for a new host) is distinguished from all the identification information of all other hosts 104. In one embodiment, the most recently received new host identification information is put at the top or beginning of the list of all host identification information display records. However, it is within the scope of the present invention that other distinguishing presentation techniques may be used such as putting the most recently received new host information at the bottom of the portion of the list of all hosts currently being displayed to the NSS administrator. Alternatively, the most recently received host information may be displayed in a reserved area on the NSS administrator's display 164 and/or highlighted. For example, in FIG. 4A all new hosts are presented in a list that only includes new hosts.

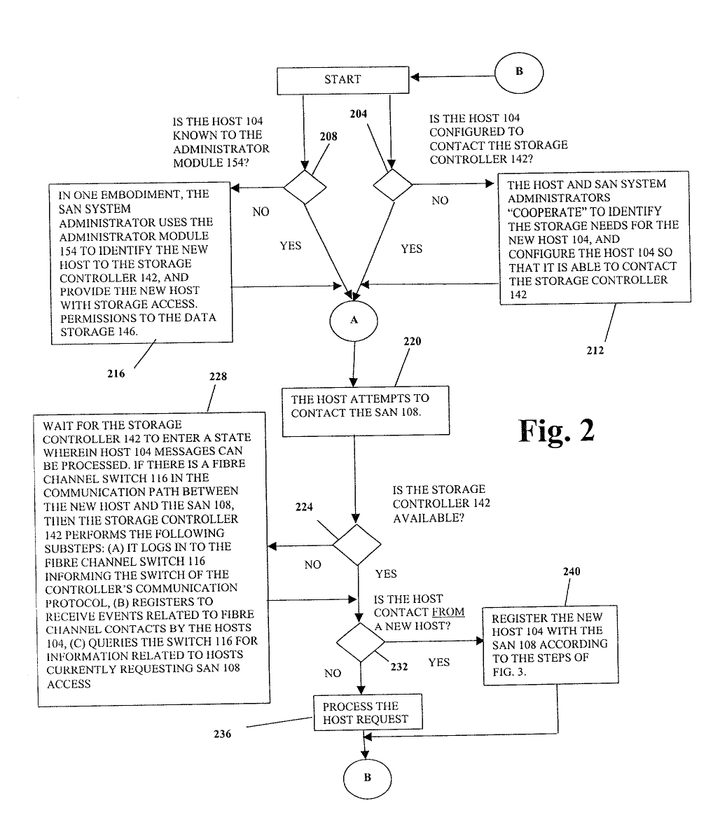

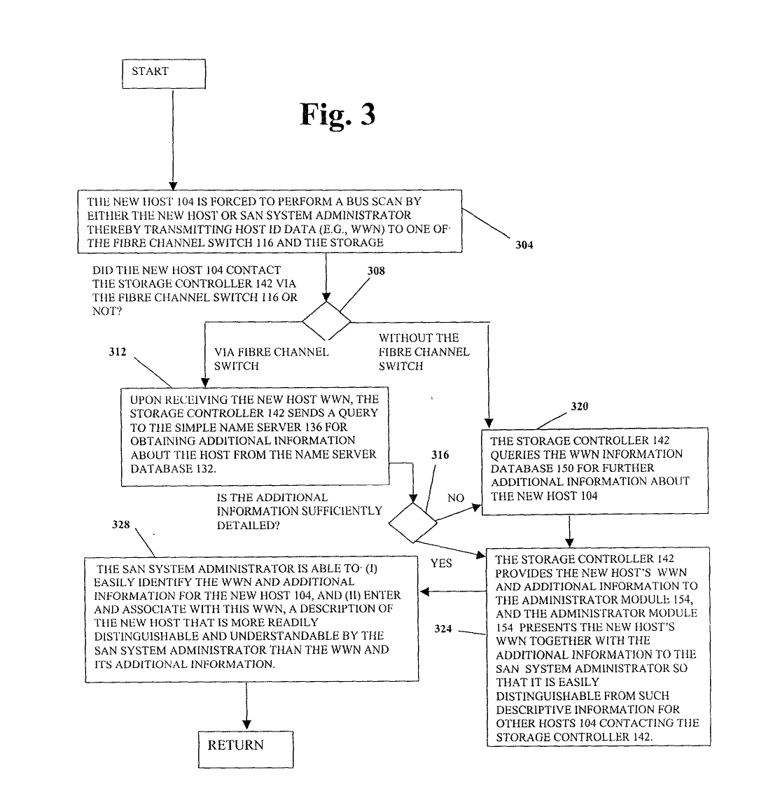

FIG. 2 is a flowchart showing the high level steps performed by an embodiment of the present invention, and in particular, the steps performed for a new host 104 to be fully registered with the NSS 108 thereby having the ability to access data storage 146. Steps 204 and 208 are decision steps whose ordering is, in general, can vary depending on the embodiment; i.e., they may be performed concurrently or one following the other. Note that the term “contact” as used with regard to a host “contacting” the storage controller 142 in the steps of FIG. 2 refers to providing information that is subsequently used by the network storage system 108 to provide access permissions and/or access to the data storage 146. In step 204 a determination is made as to whether a host 104 is configured to contact the storage controller 142. Accordingly, if the host 104 is not configured to contact the storage controller 142, then in step 212 the system administrator(s) for the new host 104 and the NSS 108 cooperate to determine the data storage needs of the host 104, and configure the new host 104 so that it requests NSS 108 access to particular logical data storage units via their corresponding LUN identifiers therefor. In particular, the host system administrator may configure the host 104 as follows: physically connect the host adapter 120 to the storage area network 112 and configure the host adapter to allow communication with this network. Regardless of the result of step 204, an attempt to contact the storage controller 142 of the NSS 108 may be delayed until particular steps are performed by the NSS administrator (e.g., as shown in steps 212 and 216 of FIG. 2). Accordingly, it is assumed here that the NSS administrator performs step 208 for determining whether the NSS 108 (and more particularly, the administration subsystem 154) has access to a descriptive host data entry describing the host 104 (i.e., whether the NSS 108 knows the host 104). If the result from step 208 is negative, then in step 216, the NSS administrator may interact with the administration subsystem 154 so that the WWN of the host 104 (such a host denoted as a “new host”) is supplied to the storage controller 142 thereby allowing the storage controller 142 to identify a contact from the host 104. However note that in an alternative embodiment, the WWN of a new host 104 may not need to be input by the NSS administrator. That is, in this alternative embodiment, the storage controller 142 may determine whether a host 104 is a new host by determining whether the NSS 108 contact by the host is due to a bus scan at the host, and if so the controller 142 captures this host's WWN for presentation to the NSS administrator as is described in the steps of FIG. 3 described hereinbelow. Note that in some instances, the system administrator for the (new) host, and the NSS administrator may be the same person. In particular, this is likely to be true (but not necessary) when the NSS 108 and the host 104 are co-located (e.g., connected on a local area network).

Assuming that all necessary steps prior to point “A” in the flow of control of FIG. 2 are performed, step 220 is performed wherein the host 104 attempts to contact the NSS 108. Thus, in step 224, a determination is made as to whether the storage controller 142 is on-line and therefore available for processing host 104 contacts. Note that this step is performed implicitly when a host 104 attempts to contact the storage controller 142. That is, if the storage controller 142 is on-line, the controller is able to provide a response to the contacting host 104, otherwise no response is forthcoming. However, note that for such hosts 104 attempting to contact the storage controller 142 via the SAN switch 116, these hosts will have registered with this switch.

If the storage controller 142 is unavailable, then step 228 is performed wherein each host 104 requesting NSS 108 contact must wait for the NSS 108 to enter an appropriate on-line state wherein the storage controller 142 can respond to host 104 transmissions. Thus, a new host 104 must also wait and/or attempt to contact the NSS 108 at a later time. However, if there is a SAN switch 116 in the communication path between a host 104 and the NSS 108, then prior to the NSS entering the on-line state, the storage controller 142 performs, the following substeps: (a) it logs in to the (each) SAN switch 116 for informing the switch of the controller's communication protocol (e.g., SCSI), (b) it registers with the SAN switch 116 to receive events related to SAN switch contacts made by the hosts 104, and (c) it queries the switch 116 for information related to hosts 104 currently requesting NSS 108 access and/or registered with the switch 116.

Alternatively, if the storage controller 142 is available (step 224), then a determination is made in step 232 as to whether the host 104 contact is from a new host. Accordingly, if the host 104 is fully registered or known to both the NSS 108 and the NSS administrator (as discussed hereinbelow), then the host's request is processed by the storage controller 142 in step 236 and subsequently the initial flowchart steps are again encountered. However, if the host 104 is a new host, then step 240 is performed wherein the new host is registered with the NSS 108 according to the steps of the flowchart of FIG. 3 which is described hereinbelow. Subsequently, as after step 236, the initial flowchart steps are again encountered.

In FIG. 3, a flowchart of the high level steps performed when a new host is to be registered with the NSS 108. In step 304, the new host 104 is forced to perform a bus scan by either the new host system administrator, or by the NSS administrator. Note that such a bus scan is at least performed by each host whenever the host 104 is rebooted since it is functionality that is required for making the host functional. Accordingly, when the new host performs the bus scan in step 304, either (i) the new host's WWN is transmitted to the storage controller via the SAN switch 116 (if the new host is connected thereto), or (ii) the new host's WWN is transmitted to the storage controller 142 independently of the SAN switch 116. Note that in (i) immediately above, the new host must register with the SAN switch 116 prior to attempting to contact the storage controller 142. Moreover, in registering with the switch 116, the new host 104 may, in addition to its WWN, typically supply to the switch additional information about itself such as: its host adapter 120 make and/or model, its preferred communication protocol, its network (IP) address, etc. Note that when the switch 116 receives the registration information from the new host 104, the SAN switch stores this information in the name server database 132 as one skilled in the art will understand.

In step 308, when the storage controller 142 is contacted by the new host 104, the storage controller determines whether this contact was transmitted via the SAN switch 116 or independently thereof (e.g., host 104c, FIG. 1). However in either case, the storage controller 142 may capture a timestamp of when the new host 104 contacts the storage controller for providing, e.g., the new host's WWN.

If the new host 104 contacts the storage controller 142 via the SAN switch 116, then step 312 is performed wherein the storage controller sends a query to the SAN switch 116 requesting any additional information that the SAN switch may have in its name server database 132 describing the new host 104. Note that the query includes the WWN for the new host 104 thereby identifying the host 104 for which such additional information is requested. Subsequently in step 316, a determination by the storage controller 142 as to whether the additional information received, in response to the query of the SAN switch 116, is sufficiently detailed. In at least one embodiment of the invention, the storage controller 142 determines whether such sufficiency is based on whether the retrieved additional information includes the manufacturer, make and model of the new host's host adapter 120. However, it is within the scope of the present invention that such sufficiency may be based on other attributes of the new host (in addition to, or, alternatively to those listed here), such as IP address.

Accordingly, if such retrieved additional information is not sufficient, or if in step 316 it is determined that the new host 104 contacted the storage controller 142 independently of the SAN switch 116, then step 320 is performed for obtaining further additional information describing the new host 104. In particular, the storage controller 142 uses the WWN to query the WWN information database 150 to at least (if possible) obtain the manufacturer of the component to which the new host's WWN corresponds (e.g., the new host's host adapter 120). As noted previously, in general, it is believed that such commercial databases provide less information about a computational component than what is typically supplied by the component itself when registering with, e.g., the SAN switch 116. Nevertheless, it is within the scope of the present invention that if a version of the WWN information database 150 is accessible that supplies sufficient descriptive additional information for each host 104, then such a version of the WWN information database 150 may be the sole source accessed for the additional information for describing hosts 104. Further, note that it is within the scope of the invention for the storage controller 142 to access one or more additional databases for obtaining such additional information describing the new host 104.

Regardless of the flow of control path taken from step 316, step 324 is now performed wherein the storage controller 142 provides the new host's WWN and the (any) additional information (e.g., the timestamp of the new host 104 contact) obtained to the administration subsystem 154. In turn, the administration subsystem 154 displays the new host's WWN and such corresponding additional information to the NSS administrator. Note that it is an aspect of the present invention to provide SAN system administrator user interface functionality wherein the WWN and corresponding additional information for each new host 104 is distinguished from the other host 104 descriptive entries so that the NSS administrator can easily identify the entry for the new host. In one embodiment, each new host descriptive entry is provided at the top or at the beginning of the list of all hosts 104 that are currently identifiable by the storage controller 142. However, additional user interaction techniques such as a change in color, highlighting, placing the new entry in a predetermined location on the NSS administrator's display 164 (e.g., at the top or bottom of the display), or separating such new entries in a different display window from NSS known hosts are also within the scope of the present invention. It is, however, important to note that the user interaction technique used should allow a plurality of new host 104 entries to be accessed easily by the NSS administrator. In particular, when such new entries are output by the administration subsystem 154 for display within a time period that is shorter than it takes the NSS administrator to process such entries, it is preferable that such new entries be presented to the NSS administrator in a consistent manner, and preferably starting from a same portion of the display. Moreover, new host 104 entries should be, to the degree possible, all provided on a single screen of the display 164. Furthermore, all (time-wise) closely spaced new entries (e.g., that are too closely spaced for the NSS administrator to review each one before another displays) should be accessible without the NSS administrator having to scroll or otherwise refresh the display 164 to identify new host entries that might otherwise be interspersed among other host entries. Accordingly, by providing all such new entries at, e.g., the beginning of the list of host descriptive entries, all such entries that the NSS administrator must review are likely to be contiguous on the display 164 and provided in a uniform pattern that is easy for the NSS administrator to identify and access. Accordingly, in one embodiment, the host ID processing subsystem 160 of the administration subsystem 154 sorts or otherwise orders the new host descriptive entries according to the time each is initially generated by the administration subsystem, wherein the descriptive host entries with the most recent times are at the beginning of the list. Note that other alternative times may be used for ordering the entries of the list such as the timestamp of each new host's WWN at the storage controller 142, or other times that substantially result in the same ordering.

Subsequently, in step 328, once the NSS administrator has located the new host 104 descriptive entry, he/she may then supply further description information that he/she knows about the new host and/or its operating environment. In particular, the supplied further description information can be associated with the new host's WWN and (any of) the corresponding additional information that may have been retrieved so that this supplied further description information can be displayed with, or instead of, the new host's WWN and corresponding additional information. Thus, the NSS administrator can input such description information that is particularly useful to him/her and associate it with the new host. For example, if the new host 104 were in Denver, the NSS administrator might input the following description information: “Denver annex host; SysAdmin: Joe; phone: 303-123-4567” to thereby not only assist the NSS administrator in remembering the new host, but also in providing the NSS administrator with related information such as host 104 system administrator's names, phone numbers, and/or email addresses. Moreover, for any host 104 requesting or having access to data storage 146, this further description information for the host may be used by the NSS administrator in place of, or with, the WWN and (any of) the corresponding additional information for identifying the host in operations for assigning, designing or otherwise changing access permissions to one or more LUNs by the host. Thus, using this novel feature of the present invention, the NSS administrator can more easily recall and/or identify which host descriptive entries displayed on the display 164 correspond to which hosts 104, and use this further description information (instead of corresponding WWNs) in activating NSS administrative tasks. Note that such further description information may be in the form of textual (ASCII) data. However, it is within the scope of the present invention that other forms of description information may be provided, such as hyperlinks to detailed computational characteristics of the new host 104, hyperlinks to a diagram of the storage area network 112, menus and/or NSS commands for activating tasks substantially particular to the new host 104 such as: a task that autodials and provides a recorded message to a responsible person in case of an emergency. Also note that, the NSS administrator can provide or change the data storage 146 permissions in this step (328) for one or more of the logical storage units for which the new host 104 has LUNs identifying such storage units.

Accordingly, once the NSS administrator has supplied the (any) further description information and/or modified data storage 146 access permissions, he/she is then able to proceed to another new host 104 and the steps 304 through 328 may be performed again.

FIGS. 4A through 4C show various screens related to the presentation of new host descriptive entries provided by the present invention. Moreover, note that the phrase “hosts that are known to the controller” refers to new hosts whose descriptive entries are accessible by the administration subsystem 154. In FIG. 4A, the screen 404 presents on the display 164 the General LUN Zoning menu 408. This menu allows a NSS administrator to activate the following menu items:

(a) a “Display Host List” menu option 410 for displaying all new hosts,

(b) an “Add or Name Host” menu option 414 for manually adding a new host WWN or change the (any) descriptive information in descriptive entries associated with a new host 104, and

(c) an “Include All Hosts” menu option 418 for allowing all new hosts to access all storage LUNs in the data storage 146.

In FIG. 4B, the screen 430 shows the results of selecting the “Display Host List” menu option 410, wherein two hosts 104 currently requesting permissions to access the data storage 146 are identified by host descriptors 434 and 438. Note that each host descriptor 434 and 438 includes the corresponding host's WWN 442 and 446 respectively, and additionally, textual data such as the “<Qlogic>” text in the host descriptor 434. Moreover, as the “Menu Selection Help” 452 indicates, the textual data “<Qlogic>” was automatically provided by a “controller” which includes the host ID processing subsystem160 in the embodiment of FIG. 1. However, note that a NSS administrator may manually change such textual data. For example, in FIG. 4C, the textual data “<Qlogic>” and “<HP>” have been, respectively, changed by the NSS administrator to “Server #1” and “Server #2”.

Although the invention description has been substantially directed to an embodiment involving data storage including use thereof by one or more hosts under control of a storage controller, it should be understood that the aspects of the system and method of the present invention may not necessarily require use of such data storage. Instead, novel features related to obtaining and using certain information may not require that data storage be involved, particularly in the novel ways and/or manners by which such information is obtained and/or utilized in facilitating use or management of the system, such as facilitating a system administrator.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

What is claimed is:

1. A method for facilitating use of a system that includes at least one host and at least one controller, comprising:
conducting a bus scan at a first host for obtaining, by a first controller, first information for identifying said first host; and
using said first information by said first controller in facilitating use of the system.

2. The method of claim 1, wherein said bus scan is also conducted for identifying a plurality of different components operatively attached to a bus of said first host.

3. The method of claim 1, wherein said conducting step does not include activating a programmatic element, on said first host, for obtaining said first information, wherein said programmatic element is able to obtain said first information without activating a bus scan.

4. The method of claim 1, wherein said conducting step includes transmitting said first information, including a world wide name for said first host, to said first controller via a fibre channel network.

5. The method of claim 1, wherein said conducting step includes receiving by said first controller said first information, including a world wide name for said first host via a communications network.

6. The method of claim 1, wherein said using step includes configuring said first controller so that said first host has access to said at least one logical storage unit.

7. The method of claim 1, wherein said using step includes providing access to a predetermined data repository, wherein for each of a plurality of host components, said data repository includes corresponding identification data, wherein for at least most of said host components, said corresponding identification data is accessible independently of whether a host requesting access to said first storage controller includes said host component.

8. The method of claim 7, wherein said predetermined data portion includes an identification of a manufacturer of a component of said first host.

9. The method of claim 8, wherein said component includes a host adapter.

10. The method of claim 1, wherein said step of using includes presenting to an administrator host identifying data indicative of said first information, wherein said presenting of said host identifying data is distinguished from a presenting of other information for identifying at least a second host so that the administrator can identify said presentation of said host identifying data from said presentation of said other information for said second host by a display attribute that is substantially independent of a content of at least one of said host identifying data and said other information.

11. The method of claim 10, wherein said display attribute includes at least one of: a display order of said presentation of said host identifying data, a display location of said presentation of said host identifying data, and a display highlight or color of said presentation of said host identifying data.

12. The method of claim 11, wherein said display order includes providing said presentation of said host identifying data before said presentation of said other information.

13. The method of claim 1, wherein said step of using includes:
presenting, to an administrator of said first controller, host identifying data indicative of said first information;
receiving input from the administrator of separate information for identifying said first host; and
at least one of: (a) displaying said separate information with at least a portion of said host identifying data and (b) displaying said separate information in place of at least a portion of said host identifying data.

14. The method of claim 13, wherein said separate information assists the administrator in identifying said first host.

15. The method of claim 13, wherein a presentation of said separate information includes at least one of: textual data representing said separate information, a hyperlink for said separate information, and a menu for activating one or more tasks related to managing said logical storage units.

16. A method of claim 13, further including:
using, by the administrator, said separate information for at least one of: assigning, designing and changing access permissions to one or more logical storage units available to said first host.

17. A method of claim 1, wherein data storage is part of the system.

18. The method of claim 1, further including a step of obtaining a timestamp of when said first controller obtains said first information, wherein data indicative of said timestamp is available for presentation to an administrator of said first controller.

19. A method for facilitating use of a system that includes at least one host and at least one controller, comprising:
accessing, by a first controller, a network switch communicating with said first host for obtaining, by said first controller, first information for identifying said first host; and
using said first information by said first controller in facilitating use of the system.

20. The method of claim 19, wherein said using step includes determining whether said first information is: available via said network switch without accessing said first host, and includes at least one predetermined data portion for identifying said first host.

21. The method of claim 19, wherein said accessing step includes querying said network switch for said first information, wherein said first information includes at least one of: a network address for said first host and a network communications protocol used by said first host.

22. The method of claim 19, wherein said network switch is a storage area network switch that includes a fibre channel switch.

23. The method of claim 22, wherein said querying step includes providing a world wide name for said first host to a database interface component of said fibre channel switch, wherein said world wide name is used for retrieving said first information.

24. The method of claim 19, wherein said accessing step includes:
registering said first controller with said network switch; and
subsequent to completion of said registering step, receiving, by said first controller, information related to said network switch that is being contacted by one or more hosts for requesting access to said first controller.

25. The method of claim 19, wherein said using step includes determining whether access to at least one of a plurality of logical storage units for said first host is to be granted.

26. An apparatus for facilitating use of a system that includes at least one controller that is accessible by one or more hosts, comprising:
a controller that:
(a) includes a network interface for receiving network transmissions from each of the one or more hosts;
(b) determines, for at least a first host of the one or more hosts, first host identifying first information from a first of said network transmissions when said first network transmission is a result of a bus scan on said first host; and
(c) sends first host identifying data indicative of said first information to an administration subsystem.

27. The apparatus of claim 23, wherein said controller accesses a network switch, via a transmission on a network, for obtaining second information for identifying the first host, wherein said transmission is provided to the network by said network interface.

28. The apparatus of claim 27, wherein one or more of:
(a) said first information includes a world wide name for the first host; and
(b) said second information includes one or more of: an identification of a manufacturer of a component of the first host, a network address for the first host, a network communications protocol being used by the first host, and a make or model of a component of the first host.

29. The apparatus of claim 26, wherein said administration subsystem includes a host identification processing subsystem for presenting said first host identifying data to an administrator for said apparatus, wherein said presentation of said first host identifying data is distinguished from a presentation of other information for identifying at least a second host so that the administrator can identify said presentation of said first host identifying data from said presentation of said other information for the second host using a display attribute.

30. The apparatus of claim 29, wherein said controller is accessed by the first host more recently than being accessed by the second host.

31. The apparatus of claim 29, wherein said display attribute is substantially independent of content of said first host identifying data.

32. The apparatus of claim 29, wherein said display attribute includes at least one of: a display order of said presentation of said first host identifying data, a display location of said presentation of said first host identifying data, and a display highlighting or color of said presentation of said first host identifying data.

33. The apparatus of claim 32, wherein said display order includes providing said presentation of said first information before said presentation of said other information.

34. The apparatus of claim 26, wherein said administration subsystem includes a host identification processing subsystem for:
(a) presenting, to an administrator of said apparatus, via a display device, said first host identifying data;
(b) receiving input, from the administrator, of third information for identifying the first host; and
(c) at least one of: (a) displaying said third information, via the display device, with at least a portion of said first host identifying data, (b) displaying said third information, via the display device, in place of at least a portion of said first host identifying data, and (c) using, by the administrator, said third information for one or more of: assigning, designing and changing access permissions to one or more logical storage units to the first host.

35. The apparatus of claim 34, wherein a presentation of said third information, via the display device, includes at least one of: textual data representing said third information, a hyperlink for said third information, and a menu for activating one or more tasks related to managing said logical storage units.

36. The apparatus of claim 26, wherein said controller accesses a data repository including identification data for identifying at least one component of the first host, and said identification data is accessible from said data repository independently of a request for access to said controller by the first host.

37. The apparatus of claim 26, further including a data store for storing data that includes at least a first data storage portion having an identifier known to at least the first host when the first host has access to said first data storage portion.

38. An apparatus for facilitating use of a system that includes at least one controller that is accessible by one or more hosts, comprising:
a controller that:
(a) includes a network interface for receiving network transmission from each of the one or more hosts;
(b) accesses a network switch, via a transmission on a network, for obtaining first information for identifying the first host, wherein said transmission is provided to the network by said network interface; and
(c) communicates with an administration subsystem related to said first information.

39. The apparatus of claim 38, wherein said controller determines, for at least the first host, second information for identifying the first host from a bus scan on the first host.

40. The apparatus of claim 39, wherein said first information includes one or more of: an identification of a manufacturer of a component of the first host, a network address for the first host, a network communications protocol being used by the first host, and a make or model of a component of the first host and said second information includes a world wide name for the first host.

41. The apparatus of claim 39, wherein said administration subsystem presents first host identifying data indicative of said second information that is distinguished from a presentation of other information for identifying at least a second host using a display attribute.

42. The apparatus of claim 41, wherein said display attribute includes at least one of: a display order related to said first host identifying data, a display location related to said first host identifying data and a display highlighting or color related to said first host identifying data.
